(19) United States
(12) Patent Application Publication
(10) Pub. No.: US 2026/0170278 A1
(43) Pub. Date: Jun. 18, 2026

(54) Probe Device for Measuring at Least One State Variable of the Organism of a Farm Animal

(71) Applicant: SMAXTEC ANIMAL CARE GmbH, Graz (AT)

(72) Inventors: Stefan Rosenkranz, Graz (AT); Stefan Scherer, Graz (AT); Manuel Frech, Hinterstoder (AT); Andreas Gleinser, Graz (AT)

(21) Appl. No.: 18/883,258

(22) PCT Filed: Mar. 22, 2023
(86) PCT No.: PCT/AT2023/060082

§ 371 Date: Sep. 12, 2024

(30) Foreign Application Priority Data
Mar. 22, 2022 (AT) A 50184/2022

(51) Int. Cl. G06K 7/10; H04B 5/24; H04L 41/0806

(52) U.S. Cl. CPC G06K 7/10336; H04B 5/24; H04L 41/0806

(57) ABSTRACT

The invention relates to a probe device for measuring at least one state variable of the organism of a farm animal and for identifying the animal, wherein the probe device is arrangeable in the gastrointestinal tract of the animal and comprises at least the following components arranged in or on a housing:
at least one sensor element for measuring at least one physical parameter in the gastrointestinal tract of the animal,
at least one internal communication device for wirelessly receiving and transmitting information, and
at least one internal computing unit configured to evaluate the signals detected by the sensor element and connected to the at least one sensor element for this purpose, and connected to the internal communication device for transmitting the data derived therefrom and for controlling, wherein the internal computing unit includes a data memory on which at least one configuration file can be stored.

The invention relates to a probe device (or bolus) for measuring at least one state variable of the organism of a farm animal and for identifying the farm animal, wherein the probe device is arrangeable in the gastrointestinal tract of the farm animal and comprises at least the following components arranged in or on a housing:
at least one sensor element for measuring at Least one physical parameter in the gastrointestinal tract of the farm animal,
at least one internal communication device for receiving and transmitting information wirelessly, and
at least one internal computing unit configured to evaluate the signals detected by the sensor element and connected to the at least one sensor element for this purpose, and connected to the internal communication device for transmitting the data derived therefrom and for controlling, wherein the internal computing unit comprises a data memory on which at least one configuration file is storable.

For example, a measuring device for measuring at least one state variable of the organism of a farm animal is known from AT 509 255A1. This measuring device can be positioned in the gastrointestinal tract of the farm animal and has a housing with components intended for the measurement. Furthermore, documents AT 515872 A1 and AT 521597 A4 each disclose a method and a system for measuring condition data or a state variable in livestock farming.

As a result of digitalization, various types of electronic devices are also increasingly being used in the field of livestock farming. One example of this is the radio-based identification of livestock, e.g. in milking parlors or automatic feeders. Implementation details have been regulated by standards since the 1990s. ISO 11784 defines a uniform bit structure for the identification signals emitted by the corresponding transponders, while ISO 11785 specifies the technical concept with which a transponder is activated and how it transmits information to a transceiver. In order to be able to continue using systems procured before the ISO standard came into force, ISO 11785 proposes in an “Annex A” that the transceiver units be equipped with slots for modules of existing technologies so that they can continue to be used. A transceiver unit is therefore dedicated to a specific type of identification transponder. Suppliers therefore usually bring identification systems onto the market in which transponders, which are attached to the foot, neck or ear of farm animals, for example, and stationary transmitter/receiver units are matched to each other and sold together. RFID technology is a solution known in the state of the art, in particular for the contactless identification of objects and living beings. RFID stands for “radio frequency identification”. Such a system has an RFID transponder (hereinafter also referred to as an RFID unit or tag) and an associated reader (hereinafter also referred to as a reader or RFID reader). The RFID transponder essentially consists of an integrated circuit or chip and an antenna and can be active or passive. In the passive version, the transponder does not have its own power supply, but is operated via the electromagnetic energy that is transmitted by the reader, for example, when the information stored on the transponder is to be read.

Digitalization is also increasingly helping to monitor the health and performance data of individual farm animals. Individual animals are also fitted with sensors that are controlled and read by associated transmitter/receiver units which are usually stationary in stables or pastures. For example, collar or rumen sensors are commonly used. While these measures can improve and simplify herd management, they also increase the complexity on farms: A large number of systems need to be installed, operated and maintained. At the same time, farm animals are fitted with multiple transponders and sensors, which is also time-consuming, error-prone and detrimental to animal welfare.

One way to simplify operations and processes is to combine several tasks in one transponder. For example, in such a combined transponder, a health sensor for measuring physiological parameters of a farm animal could also be used for animal identification. However, this creates new problems, as health data and animal identification are read out via different transmitter/receiver units. In many cases, farms already have corresponding systems installed and in use-if new sensor technology is used and not all farm animals are fitted with the appropriate transponders for the transmitter/receiver units, complete herd management is no longer possible.

An object of the invention is therefore to provide a probe device that overcomes the aforementioned disadvantages of the prior art.

This object is solved with a probe device of the type initially mentioned in which, according to the invention, the information transmittable by the internal communication device comprises both identification data for identifying a farm animal and user data for transmitting information relating to the state of the farm animal, the internal communication device comprising at least one RFID unit with an RFID transmitter for wireless transmission of the identification data and at least one user data communication unit for wirelessly receiving and transmitting user data, wherein the RFID unit comprises a recognition device configured to recognize a near field of an external communication device and, in dependence on the presence of the near field, causes the RFI D transmitter to transmit the identification data, wherein the RFID unit is designed to be configurable in that it is prepared to define a communication protocol in dependence on a configuration file stored in the data memory and to encode and transmit the identification data accordingly.

The probe device according to the invention is highly compatible with existing systems and is also prepared to be adapted in the future thanks to its configurability. RFID communication can, but does not have to, be used exclusively for animal identification, although the amount of information that can be transmitted using RFID is very limited for technical reasons. It is possible that identification data is only transmitted when the near field is detected in order to minimize the power consumption of the RFID transmitter. The user data is in particular data about the respective farm animal. In addition to this, configuration data can of course also be transmitted, which can be used to configure the probe device. The configuration data can be transmitted in the same way as user data; in particular, it can be formed as part of the user data. Internal communication units, in particular the user data communication unit, can be used to send and/or receive the configuration data or a configuration file derived from it. The near field can be detected by a passively operated receiving antenna of the recognition device. The near field is e.g. 2 meters, but can be adjustable. If, for example, an access barrier to a milking station should open when a cow is detected, the detectable field, i.e. the near field, should not extend too far. The RFID unit with the RFID transmitter works in the near field by inductive coupling. A maximum reading range can be specified by the design of an RFID reader antenna. The near field of the external communication device can therefore also be described as the area surrounding the external communication device in which the RFID communication with the RFID unit of the probe device functions, whereby the spatial extent depends on the transmission power of the external communication device, the sensitivity of the probe device and the ambient conditions. The probe device can check the presence of the near field, i.e. the presence in the near field, and react depending on this, e.g. by sending the said identification data. Exactly one communication protocol is in operation at any time, even if several communication protocols are preconfigured and could be used as required. In the internal computing unit, data can be derived from the signals of the sensor elements that correspond to state variables of the organism of the farm animal, in particular a cow. This data can be transmitted as user data and/or said user data can be derived and transmitted based on it.

In particular, it may be provided that the RFID unit is prepared for the application of an FDX communication protocol and wherein the RFID unit is further configured to perform the application of the FDX communication protocol in dependence on the configuration file.

Furthermore, it may be provided that the RFID unit is prepared for the application of an HDX communication protocol and wherein the RFID unit is further configured to perform the application of the HDX communication protocol in dependence on the configuration file.

This means that the FDX or HDX communication protocols can be used to encode and transmit the identification data depending on the configuration file.

The FDX protocol is a full-duplex protocol. This is sufficiently familiar to the skilled person from the state of the art. Data can be transmitted in both directions simultaneously. The field of the reader is switched on continuously. The tag responds by loading the field (amplitude modulation).

The HDX protocol is understood to be a half-duplex protocol. This means that data can flow alternately, but not simultaneously, in both directions. The field of the reader is activated in pulses and then deactivated for a few milliseconds, for example. The pulses are intended to supply passive tags with energy. Tags can respond during this time. The frequency switching method (FSK) is typically used (0 to 134 kHz, 1 to 124 kHz).

In particular, the RFID unit can be configured to be programmable such that a communication protocol not preconfigured on the RFID unit can be fed to the RFID unit and the RFID unit is configured to use the same in dependence on the configuration file. A bootloader can be provided for this purpose, for example, which offers the possibility of a firmware update. Proprietary communication protocols can thus be subsequently loaded, for example. In addition, the RFID unit can also be prepared for the use of proprietary systems by adopting and applying proprietary specifications.

Furthermore, it may be provided that the RFID transmitter of the RFID unit is an active RFID transmitter. For example, the RFID transmitter and/or the RFID unit have their own power supply or are connected to such a power supply by wire. For example, the RFID unit can be connected to a power supply of the probe device. Alternatively, a passive RFID transmitter is also conceivable. A passive RFID transmitter does not have its own power supply or is not directly connected to one. An active RFID transmitter has a higher transmission power and therefore a greater range. The passive RFID transmitter, on the other hand, does not have its own power supply, but reacts to an electromagnetic field that can be supplied to the RFID transmitter externally. The amount of energy that can be stored in the probe device depends on the energy supply device provided and can be determined, for example, by the capacity of a rechargeable battery or a battery that the probe device comprises.

In particular, it may be provided that the transmission power and thus the range of the active RFID transmitter is adjustable in dependence on a configuration file stored in the data memory. This may be the previously mentioned configuration file or an additional file. With active support, it is sufficient if the receiver is simply sufficiently sensitive, as the transmission signal can be actively amplified.

Furthermore, the transmission power of the active RFID transmitter can be adjustable within a power range of 10% to 100% of the maximum transmission power of the RFID transmitter. The adjustability can take place in steps with a predeterminable step width. For example, steps of x% can be provided, wherein the value x can be between 1 and 10. The value x can also be specified externally depending on the sensitivity of an external receiver.

In particular, it may be provided that the recognition device of the RFID unit has an adjustable sensitivity such that the signal strength of the near field of an external communication device required for detection is adjustable. This function can be combined with the aforementioned variable transmission power or used independently of it. For example, it is also possible to keep the transmission power constant and simply optimize the near-field detection by selecting the appropriate sensitivity, so that the RFID unit prevents the identification data from being transmitted too early/too often, thereby minimizing power consumption. This can also prevent the identification data from being sent too late. For example, the active RFID transmitter can be activated from a certain proximity to the near-field transmitter. The reading range can be adjustable by setting the reception sensitivity. This setting can be made via the cloud, for example.

Furthermore, it may be provided that the RFID unit is configured to transmit and receive data in a frequency band between 115 kHz and 145 kHz, both with regard to the detection of a near field of an external communication device and with regard to the transmission of the identification data by the active RFID transmitter. This means that the antennas are set up to transmit and receive signals in this wavelength range. The information is modulated to the carrier signals within the available frequency band. For animal detection, this typically takes place in the range of 130 kHz.

In particular, it may be provided that the internal computing unit is further configured to grant access to the data memory in dependence on the data received by the internal communication device, such that a stored configuration file can be changed or a new configuration file can be replaced in dependence on the received data, such that the transmission and/or reception behavior of the internal communication device can be changed. This may involve a variation of the power, sensitivities or even the protocols.

Furthermore, it can be provided that the user data communication unit is configured to transmit and receive data within a frequency band between 400 MHZ and 1 GHz, whereby the frequency actually used is selectable at least between three frequencies that are at least 10% apart from one another. The step width can be x% of the frequency bandwidth, whereby x can be selected such that, for example, a step width of 200 kHz is possible. Alternatively, x can be a number with a value between 0.01 and 1. It can be preset depending on the configuration file.

Furthermore, it may be provided that, in addition to the information relating to the state of the farm animal, the user data comprises configuration data with which the probe device is configurable. The configuration data can be received by the internal communication device, in particular by the user data communication unit, whereby a configuration file is creatable by means of the configuration data which is transmittable to the internal computing unit via the internal communication device, in particular storable on the data memory.

Furthermore, the invention relates to a recognition system for identifying a farm animal, comprising a probe device according to the invention and at least one RFID-capable external communication device for wireless exchange of identification data with the internal communication device, wherein the external communication device is configured to transmit an RFID signal at least into a near field of the external communication device, and the internal communication device is configured to passively receive the RFID signal transmitted by the external communication device within the near field of the external communication device and, in response thereto, emit an identification signal comprising identification data of a farm animal by the RFID transmitter, which identification data is detectable by the external communication device and enables identification of the farm animal concerned.

The identification signal is preferably sent exactly once in a duty cycle, whereby the duration of the duty cycle is adjustable and is between 0.1 s and a maximum of 60 s. This can save energy.

Furthermore, it may be provided that the recognition system comprises at least one RFID-capable interposed communication device configured to emit an RFID signal at least into a near field of the interposed communication device, and the internal communication device is configured to passively receive the RFID signal emitted by the interposed communication device within the near field of the interposed communication device and, in response thereto, emit an identification signal comprising identification data of a farm animal by the RFID transmitter detectable by the interposed communication device and enabling identification of the farm animal concerned, the interposed communication device in turn being configured for wireless communication with the external communication device and thereby preferably behaving in the same way as the internal communication device with respect to the interposed communication device.

The interposed communication device acts as an “RFID repeater”. This means that, depending on requirements, antennas set up can read the transmitted data via a reader that can also be controlled and forward the read 10 to the actual reader of the external communication device. This can work, for example, via an RFID tag that is connected to the RFID reader and from which the information is received as to which 10 is to be forwarded to the actual reader. The read ID of the probe device can be passed directly or a lookup table can be stored in the reader. A read ID of an official ear tag ID can be passed on for this purpose. It is also conceivable that an RFID communication protocol according to HDX or FDX is not necessarily used, but only encoded with HDX or FDX when it is passed on to the external communication device.

Furthermore, the invention relates to a monitoring system for measuring at least one condition variable of the organism of a farm animal, comprising a probe device according to the invention, and an external computing unit configured for wireless communication with the probe device, wherein user data detected by the probe device is detectable by the external computing unit, wherein the external computing unit is further configured to access the data memory of the internal computing unit for changing the configuration file or for uploading a new configuration file to this data memory.

Furthermore, it may be provided that the external computing unit comprises an interface for connection to the internet such to be controlled online by external devices and/or by cloud data and/or to exchange data.

Of course, a complete detection system is also conceivable, i.e. comprising a detection system and a monitoring system, wherein the probe device of the detection system can also be used as a probe device for the monitoring system. Preferably, the detection system comprises a plurality of farm animals, each of which is equipped with a probe device and can thus be detected by the detection system, the monitoring system or the detection system.

The invention further relates to a method for operating a probe device according to the invention, the method comprising the following steps:
(a) determining a communication protocol of the RFID unit depending on a configuration file stored in the data memory of the internal computing unit of the probe device;
b) upon detection of a near field of an external communication device, encoding the identification data according to the defined communication protocol;
c) transmitting the identification data by the RFID transmitter of the RFID unit.

In particular, it may be provided that the identification data in step c) is passively transmitted by the RFID transmitter, preferably by means of inductive coupling with the nearfield.

Furthermore, it may be provided that the identification data in step c) is actively transmitted by the RFID transmitter.

In particular, it may be provided that the transmission power of the active RFID transmitter is set depending on the configuration file.

Furthermore, it may be provided that in a step a0) performed before step a), the configuration file in the data memory is changed or replaced by a new configuration file received via the internal communication device of the probe device, preferably via the user data communication unit.

The invention is explained in more detail below with reference to an exemplary and non-limiting embodiment illustrated in the figures.

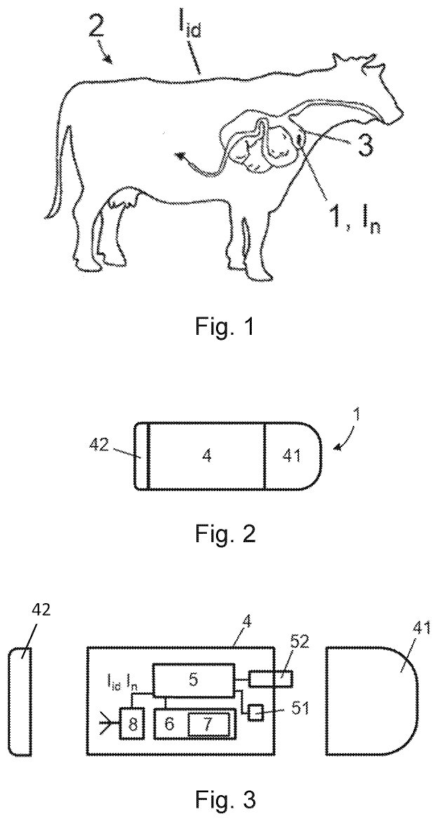

FIG. 1 shows a cow as an exemplary farm animal and the arrangement of a probe device according to the invention in its gastrointestinal tract,

FIG. 2 shows a schematic side view of the probe device according to FIG. 1,

FIG. 3 shows a schematic, partially transparent view of the probe device according to FIGS. 1 and 2,

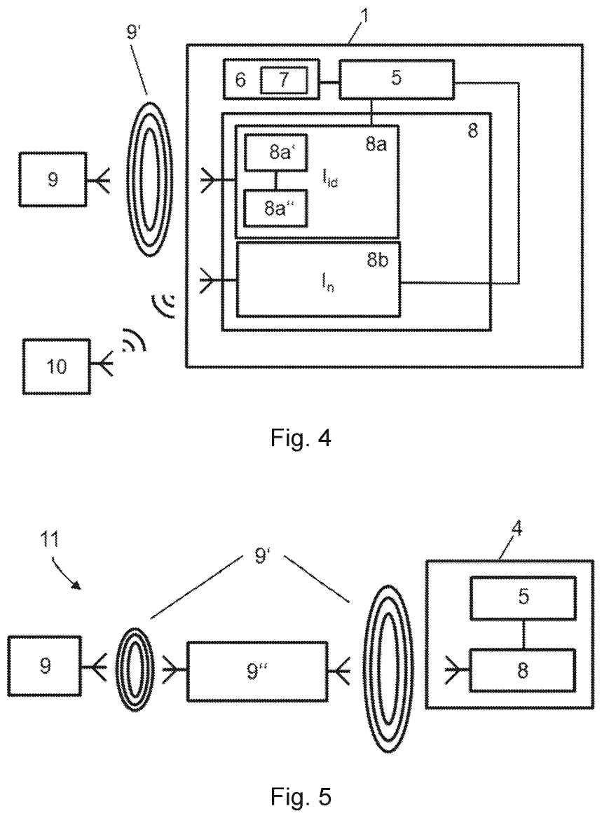

FIG. 4 shows a detailed view of the probe device and elements interacting therewith as part of a recognition and monitoring system according to the invention, and

FIG. 5 shows a recognition system comprising at least one RFIO-capable interposed communication device.

In the following figures, unless otherwise indicated, identical reference signs denote identical features.

FIG. 1 shows a sectional view of a cow 2, whereby the cow 2 is mentioned here only as a possible example of a farm animal, in particular a ruminant farm animal, into whose gastrointestinal tract 3 a probe device 1 can be inserted in accordance with the embodiment of the invention. Other suitable farm animals would be, for example, sheep, goats or even wild ruminants such as red deer. Each farm animal can be assigned an individual I_{D}, which can be detected using identification data I_{id}. The probe device 1 can detect and communicate both this identification data I_{id} and user data Iₙ.

The feed ingested and chewed by the cow 2 enters its gastrointestinal tract 3, for example the rumen or the reticulum. From the reticulum, the ingested feed is transported further into the rumen on the one hand and back into the mouth of cow 2 for rumination on the other. By measuring the condition of the cow's 2 organism or the contents of the gastrointestinal tract 3, it is possible to determine any effects or conclusions about the animal's state of health. If the pH value is too low, for example, this can lead to dangerous rumen acidosis, while changes in heart rate, rumen motility, rumination and locomotor activity allow conclusions to be drawn about the presence of milk fever, for example. The probe device 1 is therefore positioned in the animal's gastrointestinal tract 3 in order to determine the state of the animal's organism by measuring physical parameters. In particular, good results can be achieved if the probe device 1 is permanently in an end position in the reticulum. This data can be transmitted as user data Iₙ.

FIG. 2 shows a schematic side view of the probe device 1, in which it can be seen that the probe device comprises a housing 4 with a first closure element 41 and a second closure element 42.

FIG. 3 shows a schematic, partially transparent view of an embodiment example of the probe device 1: A first 51 and a second sensor element 52 for measuring physical parameters are arranged inside the housing 4 which detect corresponding signals in the gastrointestinal tract 3 of the farm animal 2, in the example embodiment a cow. The first sensor element 51 can be an acceleration sensor. The first sensor element 51 is arranged inside the housing 4 and protected by it. Of course, several sensor elements can also be provided, which are arranged inside the housing. These sensors are also referred to as internal sensors.

Alternatively or in addition to this, a second sensor element 52 can also be provided that is arranged externally from the housing 4 or protrudes outwards through it in order to come into direct contact with the stomach contents of a farm animal. This is useful, for example, when measuring the pH value. Of course, several such sensors can also be provided which can come into direct contact with the stomach contents. Such sensors can also be referred to as external sensors. The first and/or the second sensor could also be designed as a temperature sensor or comprise a temperature sensor. In addition or instead, other sensors can also be used, e.g. sensors for measuring other physical parameters such as temperature, pH value, density, pressure, conductivity, sound, optical properties, the concentration or amount of oxygen, CO2, ammonia, glucose, volatile fatty acids, acetate, propionate, butyrate and lactate or sensors for measuring the heart rate.

The sensor elements 51,52 are connected, for example, to an internal computing unit 5, which is used to control the probe device 1. The internal computing unit 5 is designed, for example, as an appropriately programmed microprocessor. The internal computing unit 5 controls and processes the data from the sensor elements 51,52. In other words, this means that in the internal computing unit 5 data is derived from the signals of the sensor elements 51, 52 which correspond to state variables of the organism of the farm animal 2, in particular a cow. This data can be transmitted as user data In or said user data In can be derived and transmitted based on it.

In operation, the probe device 1 has an energy supply device (not shown in the figures), e.g. a battery, a rechargeable battery, a (super) capacitor or a comparable device for storing and releasing electrical energy. The energy supply device is used to operate the probe device 1 and the components provided therein.

The probe device 1 is used to measure at least one state variable of the organism of a farm animal 2 and to identify the farm animal 2. For this purpose, the probe device 1 can be arranged in the gastrointestinal tract 3 of the farm animal 2 and comprises at least the following components arranged in or on a housing 4: At least one sensor element 51,52 for measuring at least one physical parameter in the gastrointestinal tract 3 of the farm animal 2, at least one internal communication device 8 for wirelessly receiving and transmitting information, and at least one internal computing unit 5 configured to evaluate the signals detected by the sensor element 51,52 and being connected to the at least one sensor element 51, 52 for this purpose, and connected to the internal communication device 8 for transmitting the data derived therefrom (which can be utilized as user data In) and for controlling, wherein the internal computing unit 5 comprises a data memory 6 on which at least one configuration file 7 is storable.

The information transmittable by the internal communication device 8 comprises both the identification data I_{id} for identifying a farm animal 2 and user data In for transmitting information relating to the state of the farm animal 2 which can be detected, for example, by means of the sensor elements 51 and 52. In addition, the user data In can be configuration data with which the probe device 1 can be configured, e.g. corresponding configuration files for operating the probe device 1 and its components. Alternatively, the configuration data can also be viewed or sent/received separately from the user data In, using the same data transmission path and thus the same hardware as for the transmission of the user data In. The configuration data can be used to create a new configuration file 7 and store it on the data memory 6, which can then be used to define the communication protocol.

FIG. 4 shows a detailed view of the probe device 4 with regard to the communication device 8 and elements interacting with it. It can be seen that the internal communication device 8 for wireless transmission of the identification data I_{id} comprises at least one RFID unit 8a with an RFID transmitter 8a′. Furthermore, it comprises at least one user data communication unit 8b for the wireless reception and transmission of user data In. The RFID unit 8a has a recognition device 8a″, which is configured to detect a near field 9′ of an external RFID-capable communication device 9 (functions here—at least partially—as a reader or RFID reader of the type described above) and, depending on the presence of the near field 9′, causes the RFID transmitter 8a′ to transmit the identification data I_{id}. The RFID unit 8a thus forms the RFID transponder or tag described above and comprises at least the RFID transmitter 8a′, the recognition device 8a″ with corresponding receiving antenna and—depending on whether active or passive—the power supply device or a connection to the power supply of the probe device 1. The RFID unit 8a is configurable in that it is prepared to define a communication protocol depending on a configuration file 7 stored in the data memory 6 and to encode and transmit the identification data I_{id} accordingly.

It may be provided that the RFID unit 8a is prepared for the application of an FDX communication protocol and that the RFID unit 8a is further configured to perform the application of the FDX communication protocol depending on the configuration file 7. Alternatively or additionally, it may be provided that the RFID unit 8a is prepared for the application of an HDX communication protocol and wherein the RFID unit 8a is further configured to perform the application of the HDX communication protocol depending on the configuration file 7. Furthermore, it may be provided that the RFID unit 8a is configured to be programmable, such that a communication protocol not preconfigured on the RFID unit 8a can be fed to the RFID unit 8a and the RFID unit 8a is configured to use the same as a function of the configuration file 7. The person skilled in the art is aware that a programmable RFID unit 8a has a processor or another type of control device on which preconfigured communication protocols are located or to which corresponding new communication protocols can be uploaded. In this case, changes to the RFID unit 8a are made by the internal computing unit 5 of the probe device 1. This internal computing unit 5 is connected to the internal communication device 8, which includes the RFID unit 8a, and can thus make changes to the RFID unit 8a. For example, a bootloader can be used for this purpose, with which changes can be made to the RFID unit 8a.

In particular, it may be provided that the RFID transmitter 8a′ of the RFID unit 8a is an active RFID transmitter. The transmission power and thus the range of the active RFID transmitter 8a′ can be adjustable in dependence on a configuration file 7 stored in the data memory 6. In detail, it may be provided that the transmission power of the active RFID transmitter 8a′ is adjustable within a power range of 10% to 100% of the maximum transmission power of the RFID transmitter. Furthermore, it may be provided that the recognition device 8a″ of the RFID unit 8a has an adjustable sensitivity, such that the signal strength of the near field 9′ of an external communication device 9 required for detection is adjustable.

It may also be provided that the RFID unit 8a is set up to transmit and receive the data in a frequency band between 115 kHz and 145 kHz both with regard to the detection of a near field 9′ of an external communication device 9 and with regard to the transmission of the identification data I_{id} by the active RFID transmitter 8a′. Furthermore, it can be provided that the internal computing unit 5 is configured to grant access to the data memory 6 in dependence on the data received by the internal communication device 8, such that a stored configuration file 7 can be changed depending on the received data or a new configuration file 7 can be replaced, so that the transmission and/or reception behavior of the internal communication device 8 can be changed. Such new configuration data in the form of, for example, a new configuration file 7 and information relating to the state of a farm animal 2 can represent user data In within the meaning of the invention. The user data In can also be communication protocols, in particular proprietary communication protocols, of the RFID unit 8a, the adjustable sensitivity of which can enable the recognition device 8a″ to detect the nearfield 9′ of an external communication device 9 or variations in the performance, sensitivities or other protocols of the probe device 1. This user data In can be sent and received by the user data communication unit 8b. In other words, it may be provided that the user data In comprises, in addition to the information relating to the state of the farm animal 2, configuration data with which the probe device 1 can be configured. The configuration data can be received by the internal communication device 8, in particular by the user data communication unit 8b, whereby a configuration file 7 is creatable by means of the configuration data, which is transmittable to the internal computing unit 5 via the internal communication device 8, in particular storable on the data memory 6.

Furthermore, it may be provided that the user data communication unit 8b is configured to transmit and receive data within a frequency band between 400 MHz and 1 GHz, wherein the frequency actually used is selectable at least between three frequencies that are at least 10% apart from one another.

The probe device 1 forms part of a recognition system 11 and a monitoring system, which will be discussed in more detail below. The recognition system 11 for identifying a farm animal 2 comprises a probe device 1 according to the invention and at least one RFID-capable external communication device 9 for wireless exchange of identification data I_{id} with the internal communication device 8. The external communication device 9 is configured to transmit an RFID signal at least into a near field 9′ of the external communication device 9. The internal communication device 8 is configured to passively receive the RFID signal transmitted by the external communication device 9 within the near field 9′ of the external communication device 9 and, in response thereto, to emit an identification signal comprising identification data I_{id} of a farm animal 2 by the RFID transmitter 8a′, which identification data I_{id} is detectable by the external communication device 9 and enables identification of the farm animal 2 concerned.

With regard to FIG. 5, it should be mentioned that the recognition system 11 can be provided with at least one RFID-capable interposed communication device 9″ (in the form of a repeater) configured to emit an RFID signal at least into a near field 9′ of the intermediate communication device 9″, and the internal communication device 8 is configured to passively receive the RFID signal emitted by the interposed communication device 9″ within the near field of the interposed communication device 9″ and, in response thereto, emit an identification signal comprising identification data _{Iid} of a farm animal 2 by the RFID transmitter 8a′ detectable by the interposed communication device 9″ and enabling identification of the farm animal 2 concerned, the interposed communication device 9″ in turn being configured for wireless communication with the external communication device 9 and thereby preferably behaving in the same way as the internal communication device 8 with respect to the interposed communication device 9′.

Furthermore, FIG. 4 shows a monitoring system for measuring at least one state variable of the organism of a farm animal 2, comprising a probe device 1 according to the invention and an external computing unit 10 configured for wireless communication with the probe device 1, wherein user data Iₙ detected by the probe device 1 is detectable by the external computing unit 10, wherein the external computing unit 10 is further configured to access the data memory 6 of the internal computing unit 5 for changing the configuration file 7 or for uploading a new configuration file 7 to this data memory 6. It may be provided that the external computing unit 10 comprises an interface for connection to the internet such to be controlled online by external devices and/or by cloud data and/or to exchange data.

Furthermore, the invention relates to a method for operating a probe device 1 according to the invention, wherein the method comprises the following steps: a) determining a communication protocol of the RFID unit 8a depending on a configuration file 7 stored in the data memory 6 of the internal computing unit 5 of the probe device 1; b) upon detection of a near field 9′ of an external communication device 9, encoding the identification data I_{id} according to the defined communication protocol; c) transmitting the identification data I_{id} by the RFID transmitter 8a′ of the RFID unit 8a.

It goes without saying that all of the device features described above can also be used in the present method. For example, it may be provided that the identification data I_{id} in step c) is passively transmitted by the RFID transmitter 8a′, preferably by means of inductive coupling with the near field 9′. Alternatively, it may be provided that the identification data I_{id} in step c) is actively transmitted by the RFID transmitter 8a′. In particular, it may be provided that the transmission power of the active RFID transmitter 8a′ is set depending on the configuration file 7. In addition, it may be provided that in a step a0) performed before step a), the configuration file 7 in the data memory 6 is changed or replaced by a new configuration file 7 received via the internal communication device 8 of the probe device 1, preferably via the user data communication unit 8b.

The invention is not limited to the embodiments shown but is defined by the entire scope of protection of the claims. Individual aspects of the invention or of the embodiments can also be taken up and combined with one another. Any reference signs in the claims are exemplary and serve only to make the claims easier to read without restricting them.

### LIST OF REFERENCE SYMBOLS (NON-LIMITING)

1 Probe device
2 Farm animal
3 Gastrointestinal tract
4 Housing of the probe device
5 Internal computing unit
6 Data memory
7 Configuration file
41,42 Closure elements
51,52 Sensor elements (internal, external)
8 Internal communication device
8a′ RFID transmitter
8a″ Recognition device (field recognition)
8b User data communication unit
9 External communication device (RFID-capable)
9′ Near field
9″ Interposed communication device
10 External computing unit
11 Recognition system
I_{id} Identification data
Iₙ User data

1. A probe device for measuring at least one state variable of the organism of a farm animal and for identifying the farm animal wherein the probe device is arrangeable in the gastrointestinal tract of the farm animal and comprises at least the following components arranged in or on a housing:
at least one sensor element for measuring at least one physical parameter in the gastrointestinal tract of the farm animal,
at least one internal communication device for wirelessly receiving and transmitting information, and
at least one internal computing unit configured to evaluate the signals detected by the sensor element and connected to the at least one sensor element for this purpose, and connected to the internal communication device for transmitting the data derived therefrom and for controlling, wherein the internal computing unit comprises a data memory
on which at least one configuration file is storable,
characterized in that
the information transmittable by the internal communication device comprises both identification data (for identifying a farm animal and user data (for transmitting information relating to the state of the farm animal, wherein the internal communication device comprises
at least one RFID unit with an RFID transmitter for wireless transmission of the identification data and
at least one user data communication unit for wirelessly receiving and transmitting user data,
the RFID unit comprising a recognition device configured to recognize a near field of an external communication device and, in dependence on the presence of the near field, causes the RFI D transmitter to transmit the identification data, wherein the RFID unit is designed to be configurable in that it is prepared to define a communication protocol in dependence on a configuration file stored in the data memory and to encode and transmit the identification data accordingly.

2. The probe device according to claim 1, wherein the RFID unit is prepared for the application of an FDX communication protocol and wherein the RFID unit is further configured to perform the application of the FDX communication protocol in dependence on the configuration file.

3. The probe device according to claim 1, wherein the RFID unit is prepared for the application of an HDX communication protocol and wherein the RFID unit is further configured to perform the application of the HDX communication protocol in dependence on the configuration file.

4. The probe device according to claim 1, wherein the RFID unit is configured to be programmable, such that a communication protocol not preconfigured on the RFID unit can be fed to the RFID unit and the RFID unit is configured to use the same in dependence on the configuration file.

5. The probe device according to claim 1 wherein the RFID transmitter of the RFID unit is an active RFID transmitter.

6. Probe The probe device according to claim 5, wherein the transmission power and thus the range of the active RFID transmitter is adjustable in dependence on a configuration file stored in the data memory.

7. The probe device according to claim 6, wherein the transmission power of the active RFID transmitter is adjustable within a power range of 10% to 100% of the maximum transmission power of the RFID transmitter.

8. The probe device according to claim 1, wherein the recognition device of the RFID unit has an adjustable sensitivity, such that the signal strength of the near field of an external communication device required for detection is adjustable.

9. The probe device according to claim 1, wherein the RFID unit is configured to transmit and receive the data in a frequency band between 115 kHz and 145 kHz both with regard to the detection of a near field of an external communication device and with regard to the transmission of the identification data by the active RFID transmitter.

10. The probe device according to claim 1, wherein the internal computing unit is further configured to grant access to the data memory in dependence on the data received by the internal communication device, such that a stored configuration file can be changed or a new configuration file can be replaced in dependence on the received data, such that the transmission and/or reception behavior of the internal communication device can be changed.

11. The probe device according to claim 1, wherein the user data communication unit is configured to transmit and receive data within a frequency band between 400 MHz and 1 GHz, wherein the frequency actually used is selectable at least between three frequencies that are at least 10% apart from one another.

12. The probe device according to claim 1, wherein the user data comprises, in addition to the information relating to the state of the farm animal, configuration data with which the probe device is configurable.

13. A recognition system for identifying a farm animal, comprising
a probe device according to a claim 1, and
at least one RFID-capable external communication devices for wireless exchange of identification data with the internal communication device, wherein the external communication device is configured to transmit an RFID signal at least into a nearfield of the external communication device, and the internal communication device is configured to passively receive the RFID signal transmitted by the external communication device within the near field of the external communication device and, in response thereto, emit an identification signal comprising identification data of a farm animal by the RFID transmitter, which identification data is detectable by the external communication device and enables identification of the farm animal concerned.

14. The recognition system according to claim 13, wherein the recognition system comprises at least one RFID-capable interposed communication device configured to emit an RFID signal at least into a near field of the interposed communication device, and the internal communication device-is configured to passively receive the RFID signal emitted by the interposed communication device within the near field of the interposed communication device and, in response thereto, emit an identification signal comprising identification data of a farm animal by means of the RFID transmitter detectable by the interposed communication device and enabling identification of the farm animal-concerned, the interposed communication device in turn being configured for wireless communication with the external communication device and thereby preferably behaving in the same way as the internal communication device with respect to the interposed communication device.

15. A monitoring system for measuring at least one state variable of the organism of a farm animal, comprising
a probe device according to claim 1, and
an external computing unit configured for wireless communication with the probe device, wherein user data detected by the probe device is detectable by the external computing unit, wherein the external computing unit is further configured to access the data memory of the internal computing unit for changing the configuration file or for uploading a new configuration file to this data memory.

16. The monitoring system according to claim 15, wherein the external computing unit comprises an interface for connection to the internet such to be controlled online by external devices and/or by cloud data and/or to exchange data.

17. A method for operating a probe device according to claim 1, the method comprising the following steps:
a) determining a communication protocol of the RFID unit depending on a configuration file stored in the data memory of the internal computing unit of the probe device;
b) upon detection of a near field of an external communication device. encoding the identification data according to the defined communication protocol;
c) transmitting the identification data by the RFID transmitter of the RFID unit.

18. The method according to claim 17, wherein the identification data in step c) is passively transmitted by the RFID transmitter, preferably by means of inductive coupling with the near field.

19. The method according to claim 17, wherein the identification data in step c) is actively transmitted by the RFID transmitter.

20. The method according to claim 19, wherein the transmission power of the active RFID transmitter is set depending on the configuration file.

21. The method according to claim 17, wherein in a step a0) performed before step a), the configuration file in the data memory is changed or replaced by a new configuration file received via the internal communication device of the probe device, preferably via the user data communication unit
